(19) United States
(12) Patent Application Publication
(10) Pub. No.: US 2018/0276693 A1
(43) Pub. Date: Sep. 27, 2018

(54) METHOD AND APPARATUS FOR PREDICTING ACCOMMODATION DEMAND

(71) Applicant: MasterCard International Incorporated, Purchase, NY (US)

(72) Inventors: Ajay Nehra, Gurgaon (IN); Saket Kabra, Gurgaon (IN); Nishant Maheshwari, Aligarh (IN)

(21) Appl. No.: 15/879,867

(22) Filed: Jan. 25, 2018

(30) Foreign Application Priority Data
Mar. 21, 2017 (SG) 10201702289U

(51) Int. Cl. G06Q 30/02; G06Q 10/02; G06Q 50/14

(52) U.S. Cl. CPC G06Q 30/0202; G06Q 50/14; G06Q 10/02; G06Q 30/0201

(57) ABSTRACT

Method and apparatus for predicting accommodation demand is disclosed. The method comprises a computer server obtaining transaction data representing past transactions performed by a plurality of consumers via a payment network, said transaction data comprising travel addendum data; estimating for each of the consumers, based on the travel addendum data, a respective future consumer location and associated time data indicative of a time when the consumer will be at the consumer location; and predicting the at least one accommodation demand in a location at least one future time based on the future consumer locations and the associated time data.

### CROSS-REFERENCE TO RELATED APPLICATION

This application is a U.S. National Stage filing under 35 U.S.C. § 119, based on and claiming benefits of and priority to Singapore Patent Application No. 10201702289U filed on Mar. 21, 2017. The entire disclosure of the above application is incorporated herein by reference.

### FIELD OF THE INVENTION

The present invention relates to a method and apparatus for predicting accommodation demand.

### BACKGROUND OF THE INVENTION

In service industries, demand prediction leading to dynamic pricing is a common technique. Merchants try to maximize their revenue based on demand forecasts. Peak seasons/hours attract high prices, while off-seasons and hours when there is low customer demand attract low prices.

Existing methods of demand prediction rely on historical data. For example the historical data may show that most consumers visit a given country during a certain month. The historical data may also show annual trends, such as year-on-year increases in consumer visits. The estimated demand affects the prices merchants can charge and when they can schedule large-scale maintenance, refurbishments and repairs.

However the existing methods of demand estimation using historical data can be impacted by various external factors and the estimation errors can be huge. In particular, existing methods do not take account of the large number of factors that affect where consumers travel. Such factors include unusual visitor attractions (e.g. trade fairs, major sporting events, concerts or public celebrations) and natural disasters as well as the political, security and socio-economic environment. Therefore, it would be desirable to have a more effective method and apparatus for predicting accommodation demand.

### SUMMARY

The present invention aims to provide new and useful methods and computer systems (such as server systems) for predicting at least one accommodation demand.

In general terms, the invention proposes that, at least for a set of consumers for whom transaction data, including addendum data, indicates that they will in the future travel to a certain location, the transaction data is used to provide demand prediction data indicative of accommodation demand in the location.

Using the transaction data may enable reliable accommodation demand prediction, which allows accommodation providers and other related service industries to better plan refurbishment and renovation activities as well as more reliably set prices to cope with the demand.

The term “accommodation” is used here to include any one or more room(s) in which a consumer may stay overnight. For example, accommodation may be rooms at a hotel, bed and breakfast, hostel, motel, cottage, chalet, mansion, lodge, resort, villa, hacienda, aparthotel, apartment, camp, inn, manor, pension, townhouse, tent, pod, townhouse, ship, sleeper train, island or a private house. Demand is a measure of how many people require a particular type of accommodation in a given location at a given time. The location may be any sized geographic area. For example, the location may be part or all of a village, town, city, region, safari park, country, continent, resort, beach, island, port, natural attraction or visitor attraction. The location may also be a specified area around a travel hub. For example the location may be a specific distance around an airport, train station or other public transportation hub. The time may be a single, specific date or a range (plurality) of nights.

As used in this application, the terms “component,” “module,” “engine,” “system,” “apparatus,” “interface,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller itself can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. For instance, the claimed subject matter may be implemented as a computer-readable medium embedded with a computer executable program, which encompasses a computer program accessible from any computer-readable storage device or storage media. For example, computer readable media can include but are not limited to magnetic storage devices (e.g., hard disk, floppy disk, magnetic strips . . .), optical disks (e.g., compact disk (CD), digital versatile disk (DVD) . . .), smart cards, and flash memory devices (e.g., card, stick, key drive . . .).

As used in this document, the term “payment card” refers to any cashless payment device associated with a payment account, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, transponder devices, NFC-enabled devices, and/or computers. Furthermore, the “payment card” may exist only as a data structure (i.e. without physical existence), which is registered with a digital wallet or cloud wallet.

### BRIEF DESCRIPTION OF THE DRAWINGS

Embodiments of the invention will now be described for the sake of example only, with reference to the following drawings in which:

FIG. 1 is a schematic view of a computerized network including a server system which is operative to perform a method which is an embodiment of the invention;

FIG. 2 shows the steps of a method which is an embodiment of the invention; and

FIG. 3 shows schematically the structure of the server system of FIG. 1.

### DETAILED DESCRIPTION OF THE EMBODIMENTS

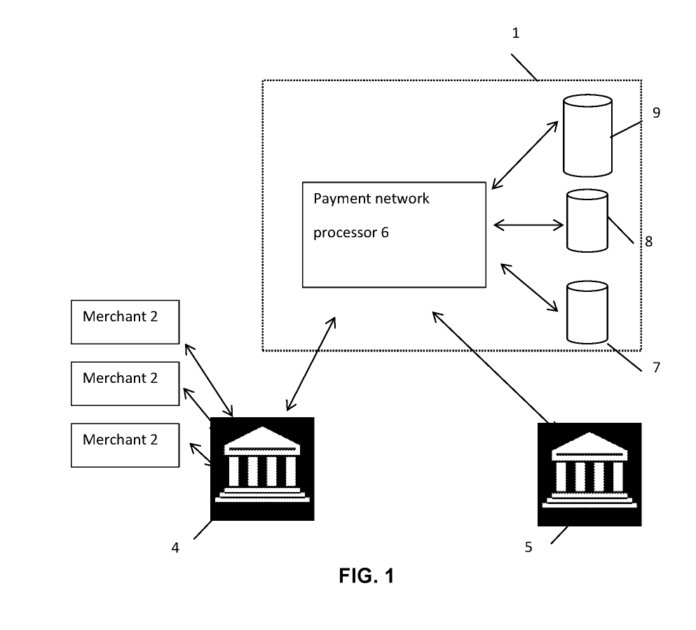

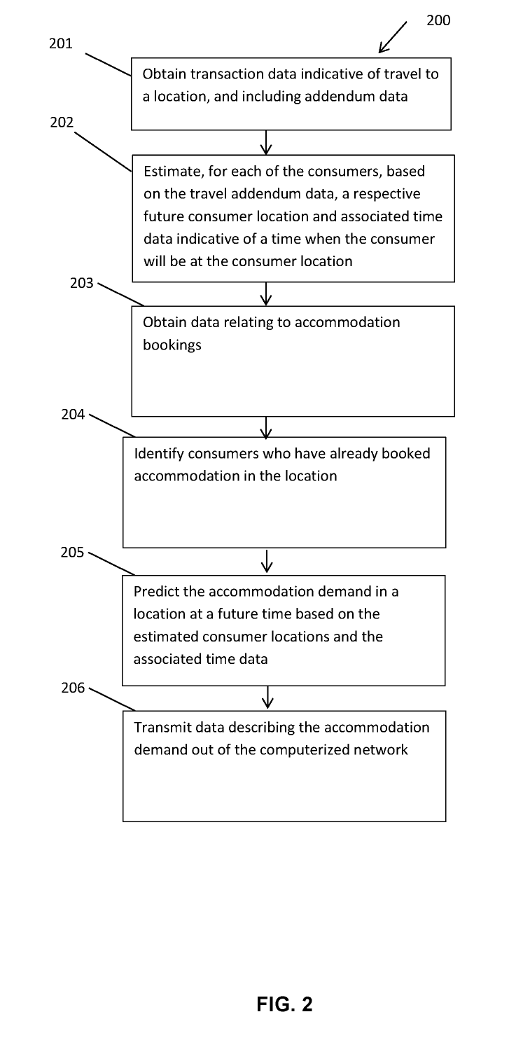

Referring first to FIG. 1, a computerized network is shown including a server 1 which can perform a method 200 which is an embodiment of the invention. The method 200 is explained below with reference to FIG. 2. The server 1 is associated with a payment network for processing payment transactions made using payment cards issued by corresponding issuer banks. For that reason, the server 1 is referred to here as a “payment network server”. The transactions include payment transactions involving merchants 2 (for simplicity, just three are illustrated). The merchants may, for example, be travel merchants. The term “travel merchant” is used here to refer to a merchant who offers any service associated with travel, such as journey tickets (e.g. flight or rail travel tickets), accommodation or vehicle rental. The term may further include a merchant providing a restaurant service at a certain location, and/or a merchant providing tourist goods at a certain location. A booking made by with a travel merchant is referred to here as a “travel booking”. The term is used to include bookings in which a payment is made and bookings in which no payment is made but the booking is secured using a payment card.

The computerized network is capable of performing a known payment process which is as follows. Typically, a consumer who holds a payment card issued by an issuer bank makes a payment by presenting his or her payment card or payment card details to a system operated by one of the merchants 2. The system sends a message to a server 4 of an acquirer bank, where the merchant maintains an account, including the details of the payment card (possibly in encrypted form) and the amount of the payment. For simplicity, FIG. 1 assumes that all the merchants 2 use the same acquirer bank 4, but in reality, the merchants will more typically use corresponding ones of a plurality of acquiring banks.

The acquirer bank server 4 sends a message to the payment network server 1, again including the details of the payment card and the amount of the payment. The payment network server 1 determines the issuer bank which issued the payment card, and sends an authorization request to an issuer bank server 5 operated by the issuer bank. For simplicity only a single issuing bank server 5 is illustrated in FIG. 1, although typically there will be many such servers associated with respective issuing banks. The issuer bank server 5 either authorizes the transaction, or declines it, and in any case sends a corresponding message to the payment network server 1, which passes the message to the acquirer bank server 4, which forwards it to the merchants 2. If the decision of the issuer bank server 5 is to authorize the transaction, then the acquirer bank server 4 credits the payment amount (possibly less a handling charge) to the account of the merchant, and the issuer bank server 5 debits it (possibly plus a handling charge) from an account associated with the payment card. At a later time (typically during a clearing operation) the issuer bank makes a payment to the acquirer bank.

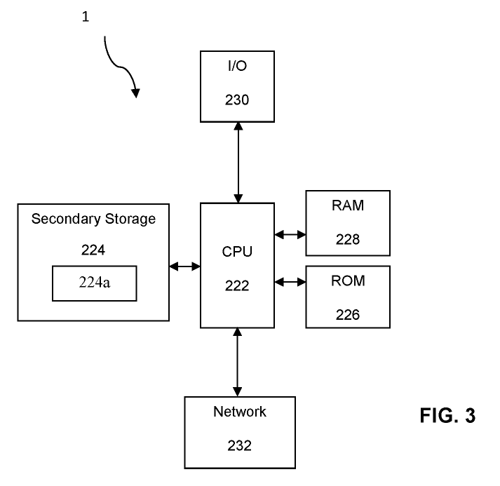

FIG. 1 shows the payment network server 1 as including a processor 6 and a plurality of databases 7, 8, 9. The structure of the payment network server 1 is explained in more detail below with reference to FIG. 3. The payment network server 1 retains transaction data including details of the payment transaction in a payment database 7. The transaction data representing past transactions may comprise the amount of the transaction, physical location of the consumer at the time the transaction occurred (or, in the case of an online transaction, any available data relating to the consumer's computer device), date and time of the transaction.

For certain of the payment transactions which are travel bookings, the transaction data comprises corresponding travel addendum data. Travel addendum data is typically present for payment transactions relating to flight bookings, and may additionally be present for payment transactions relating to rental car or accommodation bookings. The travel addendum data thus comprises information directly indicative of consumer travel plans. Some of this data might originate from prepaid bookings, blocking of funds or penny/dummy transactions. A dummy transaction is one carried out to check that card details are correct. For example, when a person registers a new payment card with an online merchant, the merchant may debit a charge as small as $1, and then refund it back. Thus, there is no net transaction, but the card details are verified. The travel addendum data may include the location of the travel booking, the number of tickets purchased, relevant dates, number of travellers and class of ticket booked. The class of ticket booked may be, for example, economy, business or first. Relevant dates may be for example outbound and return flight dates, date of ticket booking or duration of stay.

Unlike a conventional payment network server, the payment network server 1 includes a supplementary data database 8 and a consumer database 9. The supplementary data database 8 contains supplementary data received from merchants 2 other than as part of payment transaction data. The sever 1 may further comprise a communication interface (not shown) capable of receiving this supplementary data.

The consumer database 9 contains profile data for each of a plurality of consumers, all of whom carry one or more corresponding payment cards. Optionally, this profile data may classify the consumers according to one or more demographic and/or financial characteristics of the consumers. The consumer profile data for each of the consumers may comprise at least one of: home location, average ticket size in previous bookings, previous types of visit, previous flight cabin class, previous travel purpose, previous accommodation type, lifestyle, occupation, hobbies, salary, age, gender, marital status and family size.

FIG. 2 shows shows the steps of a method 200 carried out by the payment network server 1 after transaction data has accumulated in the payment database 7, and optionally after supplementary data has been received in the supplementary database 8.

In a first step 201 of the method 200, transaction data representing past transactions performed by a plurality of consumers is obtained from the payment database 7. The transaction data is filtered to identify payment transactions which are travel bookings and which include addendum data relevant to travel (“travel addendum data”), e.g. addendum data relating to a flight booking or a rental car booking.

In a second step 202 of the method 200, the travel addendum data for each of the corresponding consumers is used to estimate a respective future consumer location and associated time data indicative of a time when the consumer will be at the consumer location. The travel addendum data may indicate the consumer location directly. Alternatively, if the travel addendum data does not directly indicate the consumer location, the consumer location and respective time may be estimated from other associated data. For example, consumer location and respective time may be estimated based on the merchant and/or transaction amount. This is possible because certain merchants specialise in different aspects of travel booking (flights, hostels, room shares etc.) or specific travel locations (local travel merchants).

In a third step 203 of the method 200, data relating to accommodation bookings is obtained. This may include payment transaction data from the payment database 7 relating to accommodation bookings. Such payment transaction data may for example be identified based on the merchant to whom the payment is made.

In a fourth step 204, the data obtained in step 203 is used to identify consumers, among the consumers for whom a travel location was estimated in step 203, who have already booked accommodation at the travel location.

In a fifth step 205 of the method 200, an accommodation demand in a location at a future time is predicted based on the estimated consumer locations and the associated time data. The accommodation demand may comprise a respective accommodation demand for each of a plurality of predetermined types of accommodation. Thus for a given location, the demand for each predetermined types of accommodation may be predicted. Estimating how many consumers are going to be in a location at a future time is a useful way of predicting accommodation demand in said location.

Step 205 may include subtracting the number of consumers who, according to the result of step 204, have already booked accommodation at the location at the time from the total number of consumers who are going to be travelling to the location at the time. In this way, a more reliable prediction of accommodation demand may be provided.

Step 205 may include sub-steps to further improve the reliability or level of detail of the prediction of the accommodation demand. For example, existing consumer profile data stored in the consumer database 9 may be retrieved and incorporated into the method to better estimate what type and/or size accommodation the consumer may need. A consumer who has only stayed in luxury accommodation previously is likely to require luxury accommodation. Similarly a consumer who is known to travel with other people, for example friends or family, is likely to need a corresponding number of rooms. Average ticket size of previous bookings can help indicate the preferred price range of the consumer. The type of visits the consumer has previously made can help predict whether that consumer is likely to stay at one location only, or perhaps move to several locations during the visit. For example, a consumer may be known to prefer to visit nearby locations including different countries using other modes of transport. If the transaction data suggests that a consumer will stay at one place, the consumer profile data can therefore be important in helping predict whether the consumer may not just be visiting a location specified in the transaction data. Occupation data (including industry data) can be used to help predict the consumer location, likely purpose of travel and the likely type of accommodation required. For example, students are less likely to require luxury accommodation than consumers with high salaries. Marital status and family size may also be used to help predict the likely number of consumers that require accommodation in a given location and the type of accommodation.

The travel addendum data may also be used to predict, or to improve the prediction of, the type and/or size accommodation each consumer may need. For example the method and class of travel may indicate the type of accommodation the consumer will require. A consumer with a business or first class ticket is more likely to require luxury accommodation than a consumer who has booked an economy airline ticket. A consumer who has booked a business class ticket is likely to be travelling for business purposes, and so is likely to be travelling alone or with only a small group of people. The most likely type and/or size of accommodation required by each of the consumers can thus be calculated and used to predict the accommodation demand for the corresponding type of accommodation in a given location at a future time.

The amount and variability of the data used in the method 200 for each consumer may be used to calculate a reliability weighting for both the most likely accommodation type and size required by each consumer at a given location. The weightings can then be applied to the respective consumer data used in predicting the demand. In this way a consumer whose predicted accommodation requirements are more likely to be correct, for example because there is more information available from their profile or transaction, may be weighted more highly than one where the prediction is based on less reliable data. For example, the number of travellers may be known but there may be no data to suggest the type of accommodation required.

In a sixth step 206 of the method 200, the accommodation demand for a type of accommodation in a given location at a future time is communicated to at least one device outside the computerised network. For example, the accommodation demand may be communicated to third parties such as accommodation providers.

Having a more accurate prediction of accommodation demand for each of a plurality of predetermined types of accommodation allows accommodation providers and other related service industries to better resource each predetermined accommodation type. For example, it allows accommodation providers to better plan refurbishment and renovation activities of each predetermined accommodation type as well as more reliably set prices of each predetermined accommodation type to cope with the demand. The predicted at least one accommodation demand may also be used to predict demand in other service industries. For example, predicted accommodation demand may be used to predict restaurant, attraction and transport demand in and around the location at the time.

Many variations of the method 200 are possible. In particular, any one or more of steps 201 to 205 may further employ supplementary data from the supplementary database 8. This is useful, for example in cases in which the transaction data in the payment database 7 is not sufficiently detailed. In these situations, it may be difficult to reliably predict the consumer location at a respective time from the transaction data alone.

Comparing the transaction data with the supplementary data allows portions of the transaction data to be associated with (i.e. matched with) corresponding portions of the transaction data relating to the same transaction. As an example, the transaction data may disclose that a consumer spent a certain amount of money at a certain travel merchant, but the transaction data may not disclose what the payment related to. However, the corresponding portion of the supplementary data may indicate that the transaction related to a flight to and/or from a specific location on specific date(s), and/or a rental car or restaurant reservation on specific dates, and/or the transaction related to an accommodation booking on specific night(s). Thus a more complete record of the consumer travel plans and reliable prediction of accommodation demand may be provided.

The supplementary data may be anonymised, which may make the matching operation more complex. However, combining the transaction data with the supplementary data may allow matching of transaction data with corresponding portions of the supplementary data. For example, if both a portion of the transaction data, and a portion of the supplementary data, describe a payment made to a certain merchant at a certain time and for a certain amount, it may be inferred that the transaction referred to is the same, and thus the portion of transaction data is associated with the portion of supplementary data. Thus a more complete record of the consumer travel plans and reliable prediction of accommodation demand may be provided.

The supplementary data may also be useful when the supplementary data relates to transactions or bookings which used an alternative method of payment to a payment card (such as cash) or which were carried out on a different payment network from which data cannot be directly obtained by the payment network server 1. In particular, portions of the supplementary data which cannot be associated with the transaction data can be used to give an indication of the proportion of travel bookings which have been made other than using the payment network server 1, so that the results obtained in step 205 can be extrapolated to cover such travel bookings

FIG. 3 is a block diagram showing a technical architecture of the payment network server 1. The technical architecture includes a processor 222 (which may be referred to as a central processor unit or CPU) that is in communication with memory devices including secondary storage 224 (such as disk drives), read only memory (ROM) 226, random access memory (RAM) 228. The processor 222 may be implemented as one or more CPU chips. The technical architecture may further comprise input/output (I/O) devices 230, and network connectivity devices 232.

The secondary storage 224 is typically comprised of one or more disk drives or tape drives and is used for non-volatile storage of data and as an over-flow data storage device if RAM 228 is not large enough to hold all working data. Secondary storage 224 may be used to store programs which are loaded into RAM 228 when such programs are selected for execution.

In this embodiment, the secondary storage 224 has a processing component 224a comprising non-transitory instructions operative by the processor 222 to perform various operations of the method of the present disclosure. The ROM 226 is used to store instructions and perhaps data which are read during program execution. The secondary storage 224, the RAM 228, and/or the ROM 226 may be referred to in some contexts as computer readable storage media and/or non-transitory computer readable media.

I/O devices 230 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 232 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 232 may enable the processor 222 to communicate with the Internet or one or more intranets. With such a network connection, it is contemplated that the processor 222 might receive information from the network, or might output information to the network in the course of performing the above-described method operations. Such information, which is often represented as a sequence of instructions to be executed using processor 222, may be received from and outputted to the network, for example, in the form of a computer data signal embodied in a carrier wave.

The processor 222 executes instructions, codes, computer programs, scripts which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

Although the technical architecture is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 220 to provide the functionality of a number of servers that is not directly bound to the number of computers in the technical architecture 220. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third-party provider.

It is to be understood that by programming and/or loading executable instructions onto the technical architecture, at least one of the CPU 222, the RAM 228, and the ROM 226 are changed, transforming the technical architecture in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

Whilst the foregoing description has described exemplary embodiments, it will be understood by those skilled in the art that many variations of the embodiment can be made within the scope and spirit of the present invention.

For example, although the explanation of the embodiment given above has referred to a single payment network server 1, in other embodiments the steps 201 to 206 may be carried out a separate server from the one which operates the payment network, but which shares certain databases with it. Furthermore, steps 201 to 206 may be performed by corresponding ones of multiple network servers 1 in communication with each other.

1. A computer-implemented method for predicting at least one accommodation demand, comprising a computer server:
obtaining transaction data representing past transactions performed by a plurality of consumers via a payment network, said transaction data comprising travel addendum data;
estimating for each of the consumers, based on the travel addendum data, a respective future consumer location and associated time data indicative of a time when the consumer will be at the consumer location; and
predicting the at least one accommodation demand in a location at least one future time based on the future consumer locations and the associated time data.

2. A computer-implemented method according to claim 1, wherein the travel addendum data comprises airline, rental car or accommodation booking data.

3. A computer-implemented invention according to claim 1, wherein the at least one accommodation demand comprises a respective accommodation demand for each of a plurality of predetermined types of accommodation.

4. A computer-implemented method according to claim 3, further comprising: estimating for each of the consumers, using existing consumer profile data, the most likely type of accommodation required by each consumer, and using the most likely type of accommodation to predict the accommodation demand for the corresponding type of accommodation.

5. A computer-implemented method according to claim 1, further comprising:
identifying consumers who have already booked accommodation in the consumer location at the at least one future time;
wherein the prediction of the at least one accommodation demand omits accommodation demand for the identified consumers.

6. A computer-implemented method according to claim 5, wherein the consumers who have already booked accommodation are identified using travel data which comprises accommodation payment transaction data.

7. A computer-implemented method according to claim 5, wherein the consumers who have already booked accommodation are identified using travel data which comprises supplementary data other than transaction data.

8. A computer-implemented method according to claim 1, further comprising:
estimating for each of the consumers, using existing consumer profile data, the most likely number of rooms required by each consumer, and using the most likely number of rooms to predict the at least one accommodation demand.

9. A computer-implemented method according to claim 8, wherein the consumer profile data comprises at least one of: average ticket size in previous bookings, previous type of visits, previous flight cabin class, previous travel purpose, occupation, salary, age, gender, marital status and family size.

10. A computer system for predicting accommodation demand, the computer system comprising:
a processing device;
a data storage device storing program instructions operative, when performed by the processing device, to cause the processing device to:
obtain transaction data representing past transactions performed by a plurality of consumers via a payment network, said transaction data comprising travel addendum data;
estimate for each of the consumers, based on the travel addendum data, a respective future consumer location and associated time data indicative of a time when the consumer will be at the consumer location; and
predict the accommodation demand in a location at least one future time based on the estimated consumer locations and the associated time data.

11. A computer system according to claim 10, wherein the travel addendum data comprises airline, rental car or accommodation booking data.

12. A computer system according to claim 10, wherein the at least one accommodation demand comprises a respective accommodation demand for each of a plurality of predetermined types of accommodation.

13. A computer system according to claim 12, wherein the processing device is further configured to:
estimate for each of the consumers, using existing consumer profile data, the most likely type of accommodation required by each consumer, and use the most likely type of accommodation to predict the accommodation demand for the corresponding type of accommodation.

14. A computer system according to claim 10, wherein the processing device is further configured to:
identify consumers who have already booked accommodation in the consumer location at the at least one future time; and
wherein the prediction of the at least one accommodation demand omits accommodation demand for the identified consumers.

15. A computer system according to claim 14, wherein the processing device is configured to identify consumers who have already booked accommodation using travel data which comprises accommodation payment transaction data.

16. A computer system according to claim 14, wherein the processor is configured to identify consumers who have already booked accommodation using travel data which comprises supplementary data other than transaction data.

17. A computer system according to claim 10, wherein the processing device is further configured to: estimate for each of the consumers, using existing consumer profile data, the most likely number of rooms required by each consumer, and use the most likely number of rooms to predict the at least one accommodation demand.

18. A computer system according to claim 17, wherein the consumer profile data comprises at least one of: average ticket size in previous bookings, previous type of visits, previous flight cabin class, previous travel purpose, occupation, salary, age, gender, marital status and family size.
